(19) United States
(12) Patent Application Publication
(10) Pub. No.: US 2008/0201217 A1
(43) Pub. Date: Aug. 21, 2008

(54) Method of providing value estimates and facilitating product trade-in

(76) Inventors: Leigh Bader, Raynham, MA (US); Doug Smith, Fall River, MA (US); Alex Choi, Taunton, MA (US); Steve Scianna, Taunton, MA (US); Edward D. Smith, Plymouth, MA (US)

Correspondence Address: Mark S. Leonardo;Brown Rubnick Berlack Israels LLP, BOX IP, One Financial Center, Boston, MA, 02111, US

(21) Appl. No.: 11/706,902

(22) Filed: Feb. 15, 2007

(51) Int. Cl. G06Q 30/00

(52) U.S. Cl. 705/14; 705/37

(57) ABSTRACT

A method for providing a value estimate and facilitating the trade-in of used golf equipment is described. The method includes the steps of providing an online database of value estimates for at least one product and offering payment at least equal to the value estimate for said product. The methods of payment can be cash or a gift certificate that can be used at authorized on-line or retail stores. The value estimates can be based on current market data.

### BACKGROUND

1. Technical Field

The present disclosure generally relates to the field of facilitating the trade-in of used products, and more particularly, to a method of facilitating the trade-in of used golf equipment that provides users a method to trade-in used golf equipment in return receiving cash or redeemable coupons at a value based on value estimates determined through user access to an online database.

2. Background

Generally, when trading-in a product whether it is in a store or online, a person can first access a website to determine the value of the product. After determining the value of the product, a person takes their product to a location that will accept their product for trade-in. Typically, a person receives in-store credit so they can purchase new equipment or products. While the online value of the product may be accurate, a trade-in location is not required to give the quoted online value for the product.

For example, when a person desires to sell or trade in golf clubs they can access the PGA Value Guide. This PGA Value Guide is an online interface designed to allow a person seeking the value of a golf club or clubs to enter specific information regarding the club and receive a current market value of the club or clubs. Other such online interfaces exist to find current market value for various products.

Persons wishing to trade-in golf clubs typically must determine the value online and then trade-in the golf clubs at a store. In return for the trade-in, the store will give the person credit to purchase new goods only in that store or possibly cash. Unfortunately, because typically there is no link between a value provider such as the PGA Value Guide and a store, the store may or may not give the online value of the golf clubs. Thus, the consumer must accept the value given or shop to find a store that will give a higher value for the golf clubs.

Therefore, it would be beneficial if persons interested in trading in their used golf clubs, golf equipment, or other products had the ability trade-in their used golf equipment by obtaining a value estimate and receiving payment in the amount of the value estimate by trading in their clubs either directly on-line for a gift certificate or cash; or taking the value estimate along with the clubs to a store and receiving the value estimate. It would also be beneficial if the value estimates as listed on the website were updated frequently with current market data such that a person could expect to receive an up to date and current value estimate based.

### SUMMARY

Accordingly, a method for providing a value estimate and facilitating trade-in of a used product is disclosed. The method includes providing an online database of value estimates for at least one product. The method also includes offering a means of payment at least equal to the value estimate for said product.

In another embodiment, the user is provided with a shipping label for mailing at least one golf club to be traded-in. The golf club is received and the customer is notified of receipt.

In another embodiment, payment at least one golf club if offered to a user in the form of a redeemable Trade-In Network™ such as the PGA trade-in network credit certificate that can be redeemed at a PGA trade-in network authorized facility. Alternatively, the payment can be cash. Furthermore, in another embodiment, the user can print out the value estimate and take it with the used equipment to an authorized facility that will honor the value estimate.

In yet another embodiment, the method includes providing a method for a PGA trade-in network authorized facility to notify of redemption of coupon. The facilitator then pays the PGA trade-in network authorized facility value of the redeemed coupon.

Another embodiment provides for back office processes to inventory golf clubs that have been traded in. A purchase order is opened once a user selects payment based on a value estimate. The user ships the golf club and once received, the purchase order is closed. The user is notified of receipt of the golf club. The product is examined and the product information is inventoried. A retail price is assigned to the club based on current market data. The club can then be resold.

### BRIEF DESCRIPTIONS OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings wherein:

FIG. 1 is a flow chart illustrating a method for providing a value estimate and facilitating trade-in of golf clubs according to an embodiment of the present disclosure;

FIG. 2 is a flow chart illustrating a method for providing a value estimate and facilitating online trade in and payment according to one embodiment of the present disclosure; and

FIG. 3 is a flow chart illustrating the back office processes where trade-ins are received and processed for resale.

### DETAILED DESCRIPTION OF EXEMPLARY EMBODIMENTS

The exemplary embodiments of the method of providing a value estimate and facilitating trade-in are disclosed. It is contemplated that the method of facilitating online trade disclosed in the present disclosure may be employed for the trade-in of various products including, golf, racquet sports, other sporting goods, or any other product that a user could trade-in through by using a value estimate.

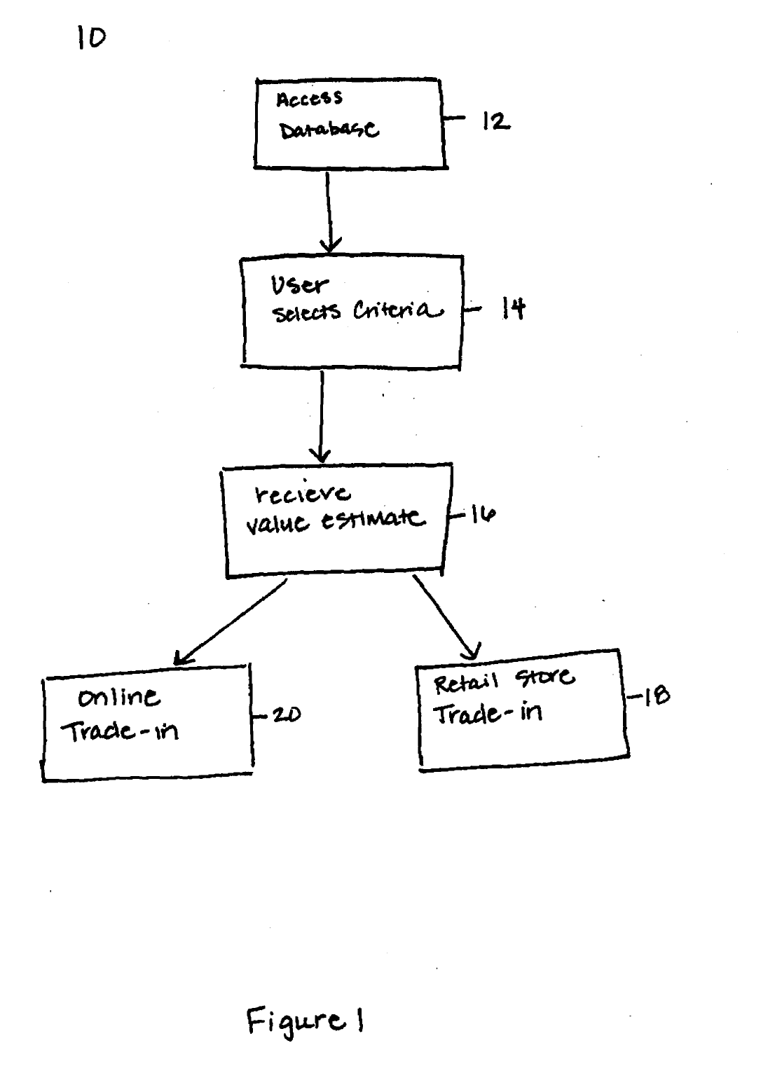

Reference will now be made in detail to the embodiments of the present disclosure that are illustrated in the accompanying figures. Turning now to the figures, attention is directed to FIG. 1. FIG. 1, is a flow chart illustrating a method 10 of providing a value estimate and facilitating trade in according to the present disclosure. A user who would like to sell, trade in or wishes to determine the value of used golf equipment accesses an online database through an internet accessible computer at step 12. Used golf equipment can include any level of used equipment including new equipment to heavily used equipment. The database includes value estimates for a variety of different golf equipment and in one embodiment the value estimates are provided by the PGA.com Value Guide.

A user enters in club criteria at step 14 and then receives a value estimate at step 16. Users are prompted to select a piece of equipment, namely a golf club that they desire to sell at step 14. The user is prompted to make selections based on manufacturing brand, type of equipment, and/or condition for the particular piece of equipment to be traded-in. Value estimates are generated based upon the information the user provides regarding piece of equipment. Manufacturer brands 10 include Adams™, Ben Hogan™, Callaway, Cleveland™, Cobra™, Mizuno™, Nike™, Odyssey™, Ping™, TaylorMade™, Titleist™, Wilson™, and a variety of other brands. It is contemplated that a user can be required to supply a wide variety of club or equipment criteria to generate a value estimate.

Each piece of equipment can be required to meet a minimum condition requirement. A minimum condition requirement ensures that that each piece of equipment meets expected standards and has value. Characteristics that may defeat a piece of equipment from meeting the minimum condition requirement include, but are not limited to, pop up marks, deep scratches, gouges, damages or missing brand, dents, dings, rust, excessive wear, broken or loose parts, non-functional grips, and other conditions that would cause the piece of equipment 6 to lose value. The minimum standard requirement gives confidence to customers who buy used products that they will receive high quality used products that still maintain value.

The value estimates listed on the PGA Value Guide web site are calculated from analyzed data which eBay™ makes available. Value estimates are based on “open market values” which can be over 100,000 weekly eBay transactions. eBay provides the “completed auction price data” that the PGA Value Guide uses to create database. This data which is used to create the database that represents the sale of virtually every golf club transaction on eBay. The database is updated frequently to ensure the most current product information.

Value estimates can also be based on “closed market” values or data or “rate card” values or data. These values can be based on a specified closed market values such as data that may be produced by in-store or online sales from a particular retailer. Similarly, value estimates can be based on “rate card” values. Rate card values are generally an internally created list of values that a particular retailer will honor when accepting trade-ins. Rate card values may be calculated in many ways, e.g. copying values from the PGA Value Guide, viewing ended auctions on eBay, based off of internal sales data of used golf clubs, educated guesses based upon some golf equipment knowledge, etc. and may or may not be reflective of current “open market” values. It is contemplated that a wide variety of methods can be employed to determine value estimates of various products.

Once a user receives a value estimate at step 16, the user has the option of online trade-in of the equipment at step 20 or taking the value estimate along with the specified equipment to a store at step 18. If a user desires to take the value estimate to a store, the user may print out the value estimate. The user can then take the value estimate along with the equipment to an authorized facility to trade-in the equipment. An authorized facility is a facility that will honor the value of the value estimate and will give the user a fair trade-in based on the value estimate. A user can determine local authorized facilities online if they determine that they would like to take the value estimate to an authorized facility such as a retail store.

One such authorized facility is a PGA trade-in network authorized facility. To qualify as a PGA trade-in network authorized facility, a golf shop must provide a high level of customer service, offer fair values for trade-ins and recognize the PGA Value Guide as the national standard resource for club value information. Membership may be limited to the 28,000 men and women golf Professionals of the PGA of America and the facilities that employ them. The PGA trade-in network authorized facilities may also include web sites such as Golfsmith™, 3balls.com™, etc. The PGA trade-in network authorized facilities can be individually owned stores or a retail chain of stores. This adds the possibility to have thousands of potential PGA trade-in network facilities versus just allowing the value estimate to be honored at a certain retail store or a certain chain of retail stores. Any type of retail store that employs a PGA Professional can be a PGA trade-in network authorized facility.

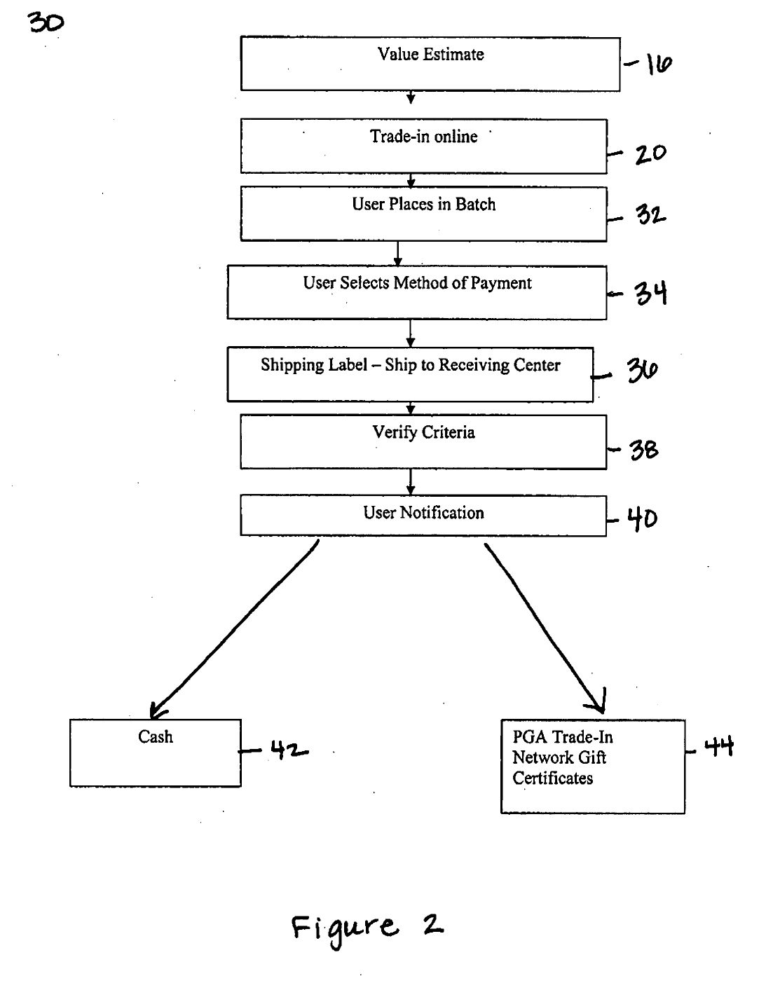

Alternatively, a user can select online trade-in as shown in step 20. Now referring to FIG. 2, by way of example, a method 30 for providing online trade-in of products is shown in accordance with the present disclosure. After a user determines a value estimate for a particular piece of golf equipment at step 16 and decides to trade-in online at step 20, the user places a piece of equipment into a batch at step 32. A batch may include one or more pieces of equipment. Once a user has completed a batch by placing one or more pieces of equipment into a batch, the user may select a method of payment at step 34. The method of payment may be cash or a gift certificate, which will be discussed below in further detail. Alternatively, a user can save their value estimate. In the event that a user decides to save their estimate, the have the option to come back later to either print it, or select a gift certificate or cash. The estimate can be updated periodically so that if a user returns to the value estimate after a substantial period of time, the value estimate will still be current. This gives the user time to decide the method of payment. The value of the payment is based on the value estimate. This makes it possible for a user to determine the actual value of the trade-in of golf equipment instead of actually going to a store to trade-in not knowing the actual value of payment before arrival at the store.

Alternatively, method of payment may be a donation. This would allow a user to make a donation rather than receiving cash or PGA trade-in network certificates. Donations could be made to a variety of different charitable foundations including, but not limited to, Susan G. Komen Breast Cancer Foundation™ and The First Tee™. By this method, a user could turn in a used product in order to make a charitable donation. The money that would typically be sent to the user would instead be forwarded to the charitable foundation.

The user can print out a shipping label for the batch at step 36. The shipping label can allow the user to ship golf equipment free of charge to PGA trade-in network receiving center. Once PGA trade-in network receiving center receives the batch, they check the batch to determine and verify criteria such as manufacturing brand, club type, and condition at step 38. Following the verification, the user is notified regarding receipt at step 40.

Users of the PGA trade-in network's online trade-in service payment is the form of cash at step 42 or PGA trade-in network gift certificates at step 44 for the equipment that was traded-in. Cash can be mailed to the user in the form of a check. A user who selects cash may receive less that what they would receive in gift certificates to promote gift certificate selection for method of payment. PGA trade-in network gift certificates can be redeemed at any one of over 4,600 participating PGA trade-in network authorized facilities nationwide. Users will receive a link to access their PGA trade-in network gift certificate through email. Users can then login to their account on the appropriate website to download and print their PGA trade-in network gift certificate. When a user redeems a PGA trade-in network gift certificate, the PGA trade-in network authorized facility notifies the facilitating company, who in turn pays the PGA trade-in network authorized facilities for the PGA trade-in network gift certificates.

The http://tradein.pgalinks.com website ties all of these PGA trade-in network authorized facilities together whether they are a chain or an individually owned store. This connection is the means by which the PGA trade-in network gift certificates can be turned in and redeemed. This connection can also negate the need for more conventional card-swipe machines at checkout to validate and redeem a PGA trade-in network credit certificate.

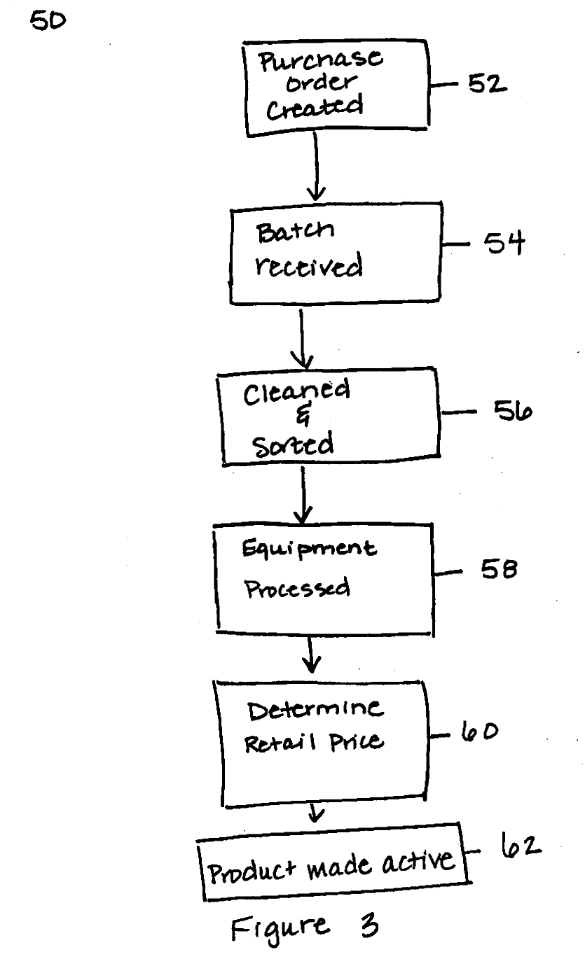

FIG. 3 is a flow chart illustrating back office processes 50 where each batch is received and processed for resale. After the user accesses the database and determines a value estimate, a purchase is automatically created at step 52. The purchase order can include information such as customer information including, but not limited to customer name, address, telephone number, and customer history. The purchase order can also include product information of equipment which makes up batch, such as brand, model or shaft type. Furthermore, the purchase order can also include pricing information.

PGA trade-in network receiving center receives the batch and purchase order is then closed at step 54. At step 56, each piece of equipment in the batch is cleaned and sorted. A person processing each piece of equipment will put a purchase order number on it. Each piece of equipment in batch becomes a sellable product at that point. At step 58, the sellable products go to the processing center where the sellable products are processed using an inventory process. A person processing products will enter the purchase order number into a custom interface. The custom interface allows a person to enter product information of each sellable product. Product information includes, but is not limited to brand, type, loft, shaft flex, and condition of sellable product. A pricing engine determines appropriate retail price at step 60. The retail price is generated from collected market data. This pricing engine is updated periodically so each club is sold at the current market price. Sellable products can be grouped together with other products with similar features. A photograph of the club will be produced and linked to the club. This photograph can be a stock photograph or a unique photograph depending on the qualities and features of each sellable product.

Once a retail price is generated, the product is made active at step 62. When a sellable product is made active, it is automatically made available for resale through various channels. For example, channels can be online sites such as 3Balls.com or eBay.

This process creates the ability to procure large volumes of used or unique goods from potentially hundred of thousands of sources and process the products quickly into sellable products through multiple online channels.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for providing a value estimate facilitating the trade-in of a used product, the method comprising:
providing an online database of value estimates for at least one product; and
offering a means of payment at least equal to the value estimate for said product.

2. The method of claim 1 wherein said product is a piece of golf equipment.

3. The method of claim 1, wherein said product must meet minimum condition requirements.

4. The method of claim 1 further comprising the step of allowing a user to save the value estimate and return to the value estimate at a later time.

5. The method of claim 4 wherein said saved value estimate it updated periodically.

6. The method of claim 1 further comprising the step of allowing a user to print said value estimate and take it to a retail store along with the product to be traded in and receive said value estimate for said product.

7. The method of claim 1 wherein said means of payment is a printable gift certificate.

8. The method of claim 1 wherein said means of payment is a printable PGA trade-in network Gift Certificate.

9. The method for of claim 1 wherein said means of payment is cash.

10. The method of claim 1 wherein said means of payment is a donation.

11. The method of claim 1 wherein said means of payment is redeemable online.

12. The method of claim 1 wherein said means of payment is redeemable at a retail store.

13. The method of claim 1, wherein said means of payment is redeemable at a PGA trade-in network authorized facility.

14. The method of claim 13, wherein said PGA trade-in network authorized facility is a chain retail store.

15. The method of claim 13, wherein said PGA trade-in network authorized facility is an individually owned retail store.

16. The method of claim 1 wherein said value estimates are calculated from current market values for said product.

17. The method of claim 16 wherein said current market values for said product are determined from open market data.

18. The method of claim 14 wherein said open market data is eBay sales data.

19. The method of claim 16 wherein said current market values for said product are determined from closed market data.

20. The method of claim 16 wherein said current market values for the product are determined from rate card data.

21. The method of claim 1 further comprising the step of providing a means for mailing in the product.

22. A method for providing a value estimate facilitating the trade-in of a used product, the method comprising:
providing an online database of value estimates for golf equipment;
providing a means of mailing for at least one piece of golf equipment to be traded-in;
receiving said golf equipment; and
offering a means of payment for said golf equipment.

23. The method of according to claim 22 wherein said payment is a printable gift certificate.

24. The method of claim 23 wherein said printable gift certificate is a printable PGA trade-in network credit certificate.

25. The method of claim 22 wherein said means of payment is cash.

26. The method of claim 22 wherein said means of payment is a donation.

27. The method of claim 22 wherein said means of payment is redeemable online.

28. The method of claim 22 wherein said payment is redeemable at a retail store.

29. The method of claim 22 wherein said payment is redeemable at a PGA trade-in network authorized facility.

30. The method of claim 29 wherein said PGA trade-in network authorized facility is a chain retail store.

31. The method of claim 29 wherein said PGA trade-in network authorized facility is an individually owned retail store.

32. The method of claim 22 wherein said online value estimate is calculated from current market values for said golf equipment.

33. The method of claim 32 wherein said current market values for said golf equipment are determined from open market data.

34. The method of claim 33 wherein said open market data is eBay sales data.

35. The method of claim 32 wherein said current market values for said golf equipment are determined closed market data.

36. The method of claim 32 wherein current market values for the product are determined from rate card data.

37. A method for facilitating the online trade-in of used golf clubs, the method comprising:
providing an online database of value estimates for at least one golf club based on manufacturer brand and condition;
opening a purchase order;
providing a shipping label for mailing at least one golf club to be traded-in;
receiving said golf club;
closing said purchase order;
notifying customer of receipt of golf club;
inventorying product information for said at least one golf club;
determining retail price for said at least one golf club;
offering for sale said at least one golf club;
offering payment for said golf club in the form of a redeemable PGA trade-in network credit certificate that can be redeemed at a PGA trade-in network authorized facility;
providing a method for said PGA trade-in network authorized facility to notify of redemption of coupon; and
paying said PGA trade-in network authorized facility value of redeemed coupon.

38. The of claim 37 wherein said retail price is determined from collected market data.
